(19) United States
(12) Patent Application Publication
(10) Pub. No.: US 2014/0200040 A1
(43) Pub. Date: Jul. 17, 2014

(54) Enabling Receive Diversity During Paging Channel Timeline Operation

(71) Applicant: Apple Inc., Cupertino, CA (US)

(72) Inventors: Wael S. Barakat, San Jose, CA (US); Chandra S. Chetty, Sunnyvale, CA (US); Johnson O. Sebeni, Fremont, CA (US); Raghuveer Mallikarjunan, Sunnyvale, CA (US); Swaminathan Balakrishnan, Santa Clara, CA (US); Tahir Shamim, San Jose, CA (US)

(73) Assignee: Apple Inc., Cupertino, CA (US)

(21) Appl. No.: 14/061,991

(22) Filed: Oct. 24, 2013

Related U.S. Application Data
(60) Provisional application No. 61/753,181, filed on Jan. 16, 2013.

(51) Int. Cl. H04W 68/02; H04W 76/04

(52) U.S. Cl. CPC H04W 68/02; H04W 76/048
USPC 455/458

(57) ABSTRACT

Enabling receive diversity based on detecting incorrect paging message length. A paging channel may be monitored. An indication of a paging message may be received on the paging channel. The paging message may include a message length field indicating a message length of the paging message. The message length field of the paging message may be received on the paging channel and decoded. It may be determined that the message length indicated in the message length field is incorrect. Receive diversity may be enabled for at least one subsequent paging occasion in response to determining that the message length indicated in the message length field is incorrect.

### PRIORITY CLAIM

The present application claims benefit of priority to U.S. Provisional Application No. 61/753,181 titled “Enabling Receive Diversity During Paging Channel Timeline Operation” and filed on Jan. 16, 2013, whose inventors are Wael S Barakat, Chandra S Chetty, Johnson O Sebeni, Raghuveer Mallikarjunan, Swaminathan Balakrishnan, and Tahir Shamim, which is hereby incorporated by reference in its entirety as though fully and completely set forth herein.

### FIELD

The present application relates to wireless devices, and more particularly to a system and method for enabling receive diversity during paging channel timeline operation by a wireless device.

### DESCRIPTION OF THE RELATED ART

Wireless communication systems are rapidly growing in usage. Many wireless communication technologies utilize a paging channel, often in combination with discontinuous reception (DRX) techniques, as a way of implementing an energy efficient idle mode of operation. In such systems, a wireless device may be able to “sleep” (operate in a low-power state) for significant blocks of time, while periodically “waking up” (operating in an active state) to monitor the paging channel and potentially performing various other activities.

### SUMMARY OF THE INVENTION

Embodiments are presented herein of various methods for operating wireless devices in conjunction with paging channel timelines, and of wireless devices configured to implement the various methods.

In particular, techniques are described providing features for detecting and responding to incorrectly decoded paging message lengths. Among other features, the techniques may provide features enabling a wireless device to cease attempting to decode paging messages which (due to the incorrectly decoded paging message length) are known to be invalid. Additionally, or alternatively, the techniques may provide features for improving the chances of correctly receiving subsequent paging messages in response to detecting an incorrectly decoded paging message length, such as receive diversity.

The techniques described herein may be implemented in and/or used with a number of different types of devices, including but not limited to, cellular phones, portable media players, portable gaming devices, tablet computers, and/or any of various other types of computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of the embodiments is considered in conjunction with the following drawings, in which:

FIG. 1 illustrates an exemplary (and simplified) wireless communication system;

FIG. 2 illustrates a base station (BS) in communication with user equipment (UE);

FIG. 3 illustrates an exemplary block diagram of a UE;

FIG. 4 illustrates an exemplary block diagram of a BS; and

FIG. 5 is a flowchart diagram illustrating an exemplary method for a UE to enable receive diversity during paging channel timeline operation.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

The following acronyms are used in this disclosure:

UE: User Equipment

BS: Base Station

3GPP: Third Generation Partnership Program

3GPP2: Third Generation Partnership Program 2

RAT: Radio Access Technology

GSM: Global System for Mobile Communication

UMTS: Universal Mobile Telecommunication System

LTE: Long Term Evolution

### TERMS

The following is a glossary of terms used in this disclosure:

Memory Medium—Any of various types of non-transitory memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems devices which are mobile or portable and which performs wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), laptops, PDAs, portable Internet devices, music players, data storage devices, or other handheld devices, etc. In general, the term “UE” or “UE device” can be broadly defined to encompass any electronic, computing, and/or telecommunications device (or combination of devices) which is easily transported by a user and capable of wireless communication.

Base Station—The term “Base Station” has the full breadth of its ordinary meaning, and at least includes a wireless communication station installed at a fixed location and used to communicate as part of a wireless telephone system or radio system.

Processing Element—refers to various elements or combinations of elements. Processing elements include, for example, circuits such as an ASIC (Application Specific Integrated Circuit), portions or circuits of individual processor cores, entire processor cores, individual processors, programmable hardware devices such as a field programmable gate array (FPGA), and/or larger portions of systems that include multiple processors.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. In contrast, WLAN channels may be 22 MHz wide while Bluetooth channels may be 1 Mhz wide. Other protocols and standards may include different definitions of channels. Furthermore, some standards may define and use multiple types of channels, e.g., different channels for uplink or downlink and/or different channels for different uses such as data, control information, etc.

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

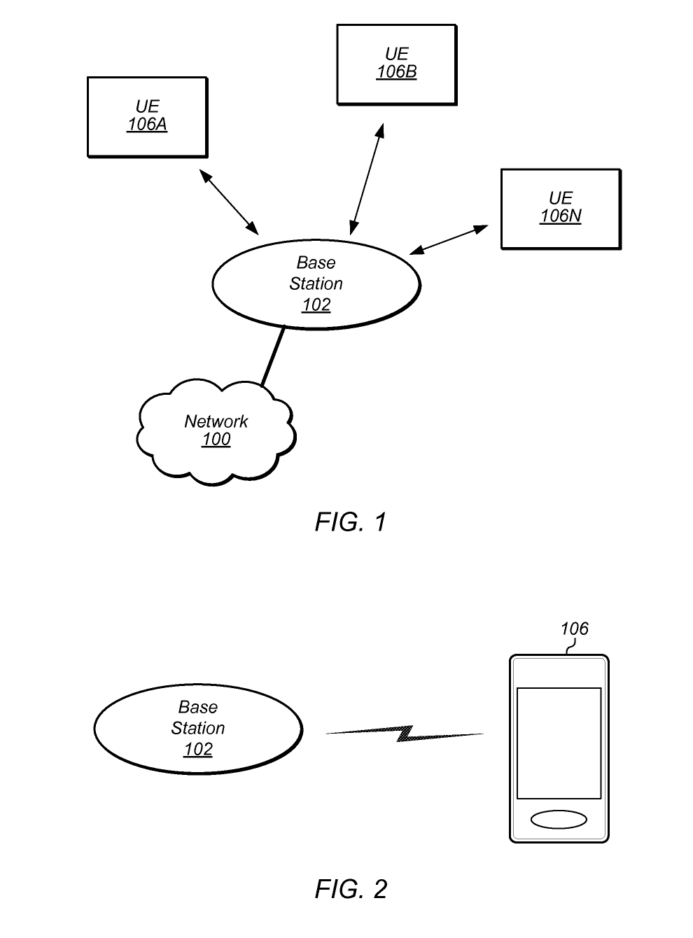

### FIGS. 1 and 2—Communication System

FIG. 1 illustrates an exemplary (and simplified) wireless communication system. It is noted that the system of FIG. 1 is merely one example of a possible system, and features of this disclosure may be implemented in any of various systems, as desired.

As shown, the exemplary wireless communication system includes a base station 102 which communicates over a transmission medium with one or more user devices 106A, 106B, etc., through 106N. Each of the user devices may be referred to herein as a “user equipment” (UE). Thus, the user devices 106 are referred to as UEs or UE devices.

The base station 102 may be a base transceiver station (BTS) or cell site, and may include hardware that enables wireless communication with the UEs 106A through 106N. The base station 102 may also be equipped to communicate with a network 100 (e.g., a core network of a cellular service provider, a telecommunication network such as a public switched telephone network (PSTN), and/or the Internet, among various possibilities). Thus, the base station 102 may facilitate communication between the user devices and/or between the user devices and the network 100.

The communication area (or coverage area) of the base station may be referred to as a “cell.” The base station 102 and the UEs 106 may be configured to communicate over the transmission medium using any of various radio access technologies (RATs), also referred to as wireless communication technologies, or telecommunication standards, such as GSM, UMTS (WCDMA), LTE, LTE-Advanced (LTE-A), 3GPP2 CDMA2000 (e.g., 1 xRTT, 1xEV-DO, HRPD, eHRPD), Wi-Fi, WiMAX etc. Base station 102 and other similar base stations operating according to the same or a different cellular communication standard may thus be provided as a network of cells, which may provide continuous or nearly continuous overlapping service to UE 106 and similar devices over a wide geographic area via one or more cellular communication standards.

A UE 106 may be capable of communicating using multiple wireless communication standards. For example, a UE 106 might be configured to communicate using two or more of GSM, UMTS, CDMA2000, WiMAX, LTE, WLAN, Bluetooth, one or more global navigational satellite systems (GNSS, e.g., GPS or GLONASS), one and/or more mobile television broadcasting standards (e.g., ATSC-M/H or DVB-H), etc. Other combinations of wireless communication standards (including more than two wireless communication standards) are also possible.

FIG. 2 illustrates user equipment 106 (e.g., one of the devices 106A through 106N) in communication with the base station 102. The UE 106 may be a device with wireless network connectivity such as a mobile phone, a hand-held device, a computer or a tablet, or virtually any type of wireless device.

The UE 106 may include a processor that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array) that is configured to perform any of the method embodiments described herein, or any portion of any of the method embodiments described herein.

In some embodiments, the UE 106 may be configured to communicate using any of multiple radio access technologies/wireless communication protocols. For example, the UE 106 may be configured to communicate using two or more of CDMA2000, LTE, LTE-A, WLAN, or GNSS. Other combinations of wireless communication technologies are also possible.

The UE 106 may include one or more antennas for communicating using one or more wireless communication protocols. In some embodiments, the UE 106 may share one or more parts of a receive and/or transmit chain between multiple wireless communication standards. The shared radio may include a single antenna, or may include multiple antennas (e.g., for MIMO) for performing wireless communications. In other embodiments, the UE 106 may include separate transmit and/or receive chains (e.g., including separate antennas and other radio components) for each wireless communication protocol with which it is configured to communicate. In still other embodiments, the UE 106 may include one or more radios which are shared between multiple wireless communication protocols, and one or more radios which are used exclusively by a single wireless communication protocol. For example, in one set of embodiments, the UE 106 may include a shared radio for communicating using either of LTE or CDMA2000 1 xRTT, and separate radios for communicating using each of Wi-Fi and Bluetooth. Other configurations are also possible.

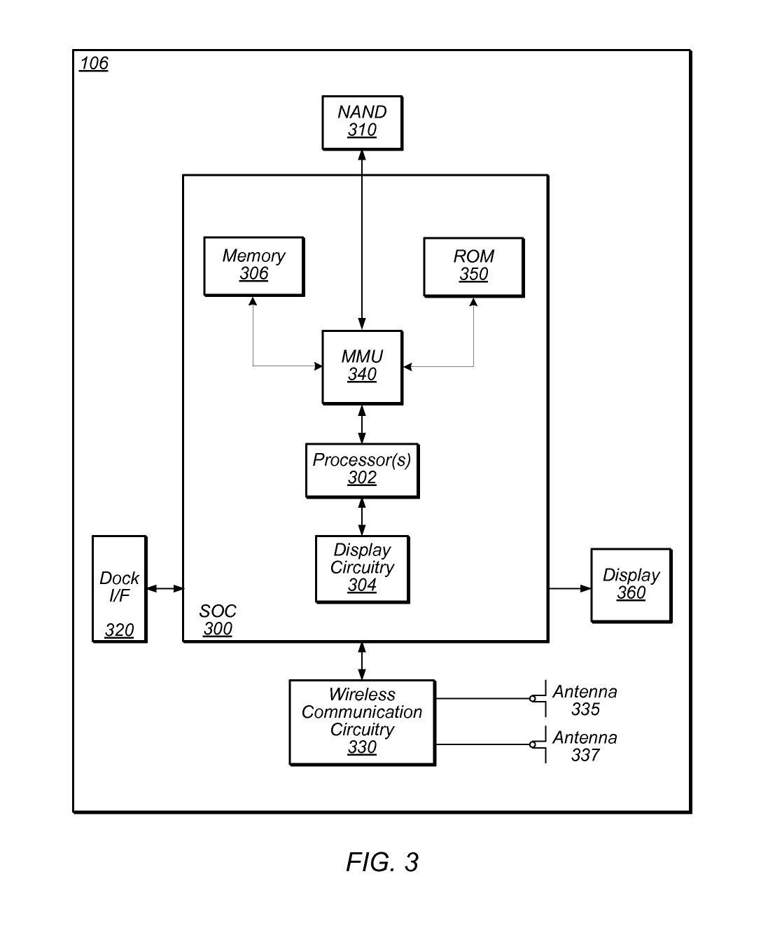

### FIG. 3—Exemplary Block Diagram of a UE

FIG. 3 illustrates an exemplary block diagram of a UE 106. As shown, the UE 106 may include a system on chip (SOC) 300, which may include portions for various purposes. For example, as shown, the SOC 300 may include processor(s) 302 which may execute program instructions for the UE 106 and display circuitry 304 which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, radio 330, connector I/F 320, and/or display 360. The MMU 340 may be configured to perform memory protection and page table translation or set up. In some embodiments, the MMU 340 may be included as a portion of the processor(s) 302.

As shown, the SOC 300 may be coupled to various other circuits of the UE 106. For example, the UE 106 may include various types of memory (e.g., including NAND flash 310), a connector interface 320 (e.g., for coupling to a computer system, dock, charging station, etc.), the display 360, and wireless communication circuitry (e.g., for UMTS, LTE, CDMA2000, Wi-Fi, GPS, etc.).

The UE device 106 may include at least one antenna, and in some embodiments multiple antennas, for performing wireless communication with base stations and/or other devices. For example, the UE device 106 may use antennas 335 and 337 to perform the wireless communication.

The UE 106 may be provided with multiple antennas for any of a number of reasons. As one possibility, the UE 106 may be provided with multiple antennas in order that the UE 106 may enable transmit and/or receive diversity some or all of the time. For example, utilizing multiple antennas to receive wireless signals may provide more robust reception capabilities, such that the wireless device may be able to successfully (e.g., accurately) receive and decode wireless signals in poorer channel conditions (e.g., decreased signal strength and/or quality, due to distance, interference, etc.) than utilizing a single antenna. However, utilizing multiple antennas may also consume more power than utilizing a single antenna, so it may not be desirable to do so in all circumstances, such as for example if channel conditions are sufficiently good to support successful reception using a single antenna.

Furthermore, as noted above, the UE 106 may be configured to communicate wirelessly using multiple wireless communication standards/radio access technologies (RATs) in some embodiments. If configured in such a way, the UE 106 may multiplex radio resources between the multiple RATs, such that it may be desirable to deploy one (or more) antennas according to one RAT at some times, and to deploy one (or more) antennas according to a different RAT at other times.

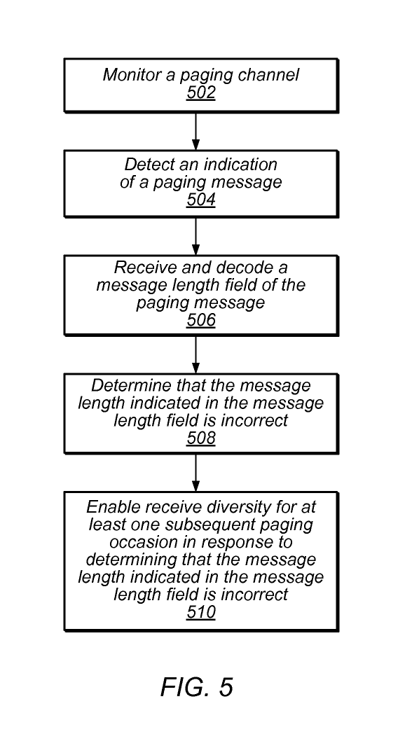

As described further herein, the UE 106 may include hardware and software components for implementing features for enabling receive diversity while monitoring and decoding the paging channel based on detecting an incorrectly decoded paging message length, such as those described herein with reference to, inter alia, FIG. 5. The processor 302 of the UE device 106 may be configured to implement part or all of the methods described herein, e.g., by executing program instructions stored on a memory medium (e.g., a non-transitory computer-readable memory medium). In other embodiments, processor 302 may be configured as a programmable hardware element, such as an FPGA (Field Programmable Gate Array), or as an ASIC (Application Specific Integrated Circuit). Alternatively (or in addition) the processor 302 of the UE device 106, in conjunction with one or more of the other components 300, 304, 306, 310, 320, 330, 335, 337, 340, 350, 360 may be configured to implement part or all of the features described herein, such as the features described herein with reference to, inter alia, FIG. 5.

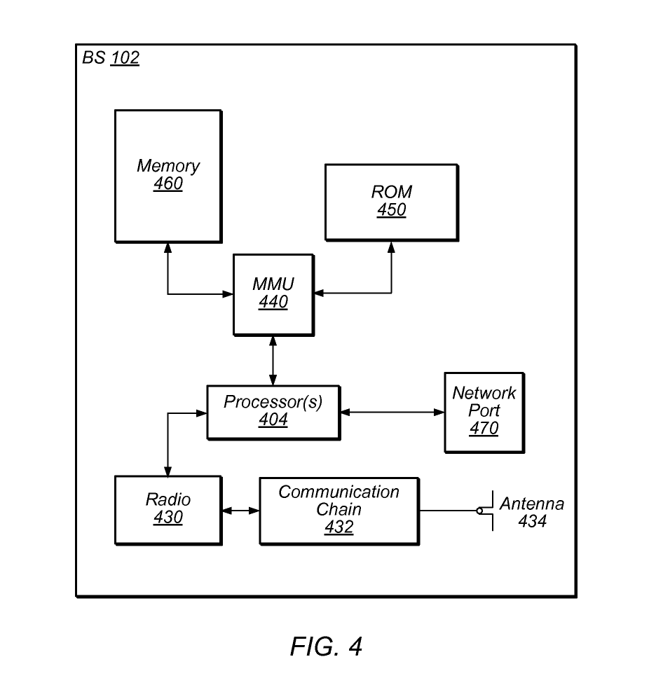

### FIG. 4—Exemplary Block Diagram of a Base Station

FIG. 4 illustrates an exemplary block diagram of a base station 102. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2.

The network port 470 (or an additional network port) may also or alternatively be configured to communicatively couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

The base station 102 may include at least one antenna 434, and possibly multiple antennas. The at least one antenna 434 may be configured to operate as a wireless transceiver and may be further configured to communicate with UE devices 106 via radio 430. The antenna 434 communicates with the radio 430 via communication chain 432. Communication chain 432 may be a receive chain, a transmit chain or both. The radio 430 may be configured to communicate via various wireless telecommunication standards, including, but not limited to, LTE, LTE-A, TD-SCDMA, WCDMA, CDMA2000, etc.

The processor 404 of the base station 102 may be configured to implement part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. Alternatively (or in addition) the processor 404 of the base station 102, in conjunction with one or more of the other components 430, 432, 434, 440, 450, 460, 470 may be configured to implement part or all of the features described herein, such as the features described herein with reference to, inter alia, FIG. 5.

### FIG. 5—Flowchart

FIG. 5 is a flowchart diagram illustrating a method for a wireless UE device 106 to enable receive diversity based on detecting paging channel message errors. The method shown in FIG. 5 may be used in conjunction with any of the computer systems or devices shown in the above Figures, among other devices. In various embodiments, some of the method elements shown may be performed concurrently, in a different order than shown, or may be omitted. Additional method elements may also be performed as desired. As shown, this method may operate as follows.

In 502, the UE 106 may monitor a paging channel. In particular, the UE 106 may monitor the paging channel for indications of incoming paging messages from a cellular network which operates according to a cellular technology supported by the UE 106. The cellular network may include a network of cells provided by base stations (such as base station 102) as well as a core network, among various possible components. The UE 106 may in particular be camped on a particular cell (a “first cell”) in the network, provided by a particular base station (a “first base station”), which may provide the UE 106 with a wireless link to the cellular network.

The cellular technology (or “radio access technology”, or “RAT”) according to which the cellular network operates and which is supported by the UE 106, may be any of various cellular technologies, such as a 3GPP or 3GPP2 cellular communication standard, including but not limited to GSM, cdmaOne, UMTS, CDMA2000 (1xRTT, 1xEV-DO, etc.), LTE, LTE-A, etc. Note that it is also possible (as previously noted, and further described subsequently herein) that the UE 106 may be configured to support multiple cellular communication technologies/standards.

Monitoring the paging channel may be part of idle-mode operation for the UE 106. In other words, the UE 106 may camp on the first cell in an idle-mode. The first cell may serve the UE 106 and provide a connection (e.g., a passive connection, in the idle-mode) to the core network. For example, to camp on the first cell in the idle-mode the UE 106 may establish a radio resource control (RRC) entity, which may operate in an RRC-idle state while the UE 106 is in the idle-mode. The nature of idle-mode operation for a UE 106 may vary according to different wireless communication technologies. Generally, the idle-mode operation may be appropriate when a UE 106 is not actively exchanging data (e.g., as part of a call or a networking application such as a web browser) with the network. In some cases the idle-mode may include a discontinuous reception or “DRX” mode. In a DRX mode, a UE 106 may generally be inactive (e.g., with one or more components, such as radio and/or baseband components, powered down or sleeping) except for a window of activity during each DRX cycle. The active portion of a DRX cycle may be scheduled in a regular periodic manner; for example, many networks schedule the active portion of DRX cycles to occur at 1.28 s intervals, or at some multiple of 1.28 s (e.g., 2.56 s, 5.12 s, etc). Other values for DRX periodicity may be used as desired.

During the active portion of a DRX cycle, the UE 106 may perform certain actions (e.g., according to the configuration of the UE 106 and/or according to configuration information received from the network). For example, the UE 106 may monitor the paging channel for paging messages, which may provide indications of incoming voice calls or data, among various possibilities. The cellular network may be configured to transmit any paging messages for the UE 106 on the paging channel at specific scheduled (typically in a regular periodic manner) occasions. The UE 106 may thus configure its DRX operation such that the active portion of each DRX cycle corresponds to these “paging occasions”, in order that the UE 106 may monitor the paging channel at the times when paging messages might be directed to the UE 106. The UE 106 may also check for/update system configuration settings, perform mobility related functions (e.g., serving and/or neighboring cell search and/or measurement, cell re-selection if necessary) and/or perform any of various other actions during the active portion of the DRX cycle. The UE 106 may then sleep in between those paging occasions, once any such other configured activities and operations are completed.

In 504, while monitoring the paging channel (e.g., as part of idle-mode DRX operation according to a radio access technology, as described above), an indication of an incoming paging message (a “first paging message”) may be detected. Various RATs may provide paging channels with different configurations, including different means of indicating to a UE 106 that an upcoming paging message is directed to the UE 106. As one possibility, the paging channel may be arranged in such a manner that certain periodically occurring indicator bits may be used to indicate the presence of an upcoming paging message.

Again depending on the particular RAT according to which the UE 106 is operating, the structure of a paging message may be variable. For at least some such RATs, however, a paging message may be structured to include a message length field, which may indicate a message length of that paging message. Thus, in 506, based on detecting the indication of the incoming first paging message, the UE 106 may receive (e.g., on the paging channel) and decode a message length field of the first paging message.

In 508, it may be determined that the message length indicated in the message length field of the first paging message is incorrect. Any of a variety of techniques may be used to determine that the message length indicated in the message length field of the first paging message is incorrect.

As one example, in some instances it may be determined directly from decoding the message length field of the first paging message that the message length indicated in the message length field of the first paging message is incorrect. For example, it may be possible that the message length indicated in the message length field may be longer than a specified maximum paging message length. In particular, although the message length field may theoretically indicate any message length up a maximum possible value of the message length field (e.g., 255 bytes for an 8 bit field, or 127 bytes for a 7 bit field, 511 bytes for a 9 bit field, etc.), it may be possible that the specification of the RAT standard according to which the UE 106 may be operating may specify a maximum possible paging message length which is less than the maximum possible value of the message length field. In other words, it may be possible for the combined maximum possible length of all possible fields of a paging message may be less than the maximum possible value of the message length field. For example, if the message length field is an 8 bit field (thus having a maximum value of 255 bytes), but the maximum possible length of a paging message according to the appropriate specification is 148 bytes, any value of the paging message length field greater than 148 may be erroneous. Note that the above example is not intended to be limiting, and that alternate examples for any of various other message length fields and/or maximum specified paging message lengths are also possible.

Accordingly, if the UE 106 determines that the message length field indicates a message length which is longer than a specified maximum paging message length, the UE 106 may determine that the message length indicated in the message length field is incorrect.

Note that it may also be possible to determine that the message length indicated in the message length field of the first paging message is incorrect based on other considerations, even if the message length indicated by the message length field is less than the specified maximum possible paging message length.

For example, after receiving and decoding the message length field of the first paging message, if the message length initially appears to be valid (e.g., less than or equal to the specified maximum possible paging message length), the UE 106 may continue to decode signals received on the paging channel according to the message length indicated by the message length field. However, if an indication of a new incoming paging message (a “second paging message”) is detected while decoding the first paging message according to the message length indicated in the message length field of the first paging message, this may be an indication of an error in decoding the first paging message. In particular, this may be an indication of an error either in the message length field of the first paging message, or the indication of the second paging message may be an error, e.g., if the cellular network does not normally interrupt a paging message to initiate a new paging message.

Thus, multiple means of determining that the message length indicated in the message length field is incorrect may be possible, including those described hereinabove and any of various other techniques. In at least some instances, the UE 106 may cease decoding the first paging message after determining that the message length indicated in the message length field is incorrect, based on determining that the message length indicated in the message length field is incorrect. For example, if the message length indicated in the message length field is larger than the specified maximum paging message length, the CRC check would fail and the message would not be successfully received, so power may be conserved by not attempting to decode the paging message in this case, potentially with little or no downside. Similarly, if an indication of a second paging message is detected on the paging channel while decoding the first paging message, in this case too it would be expected that the CRC check would fail and the message would not be successfully received, and so it may be beneficial (at least under some circumstances) to cease attempting to decode the first paging message. It may also be desirable in this scenario for the UE 106 to attempt to decode the second paging message.

Furthermore, in 510, the UE 106 may enable receive diversity for at least one subsequent paging occasion in response to determining that the message length indicated in the message length field of the first paging message is incorrect. Enabling receive diversity for a paging occasion may include using multiple antennas of the UE 106 to monitor the paging channel during that paging occasion.

The message length indicated in the message length field may be incorrect for any of a variety of reasons. One such reason may include poor channel conditions over the wireless link between the UE 106 and the first cell. Poor channel conditions, which might include poor signal strength and/or quality (e.g., due to distance between the UE 106 and the first base station; interference with other cells, other wireless devices, and/or natural features; movement of the UE 106; and/or any of various other reasons), among various possibilities, might, for example, cause the UE 106 to erroneously decode and thus misinterpret signals received on the paging channel. Enabling receive diversity, in particular by utilizing multiple antennas to monitor the paging channel, may thus (at least in some circumstances) improve the ability of the UE 106 to successfully (i.e., correctly) decode signals received in poor channel conditions.

Thus, given the potentially more robust reception capability of a UE 106 while utilizing receive diversity compared to not utilizing receive diversity, it may be desirable to at least temporarily enable receive diversity when the UE 106 determines that it has incorrectly decoded at least a portion of an incoming paging message (e.g., the paging message length field), in order to increase the likelihood of successfully/correctly decoding subsequent paging messages. Note that at least in some instances, receive diversity may be enabled under such conditions on a temporary basis, and may eventually be disabled for any of a variety of reasons. For example, there may be disadvantages to enabling receive diversity (e.g., relative to disabling receive diversity) such that it may not be desirable to permanently enable receive diversity.

For example, utilizing multiple antennas (e.g., with corresponding receivers/receive chains) may consume more power than utilizing a single antenna. Accordingly, enabling receive diversity may more rapidly deplete the battery reserves of the UE 106, which may have a negative affect on battery life of the UE 106. Alternatively, or possibly in addition, the UE 106 might be configured to operate according to (e.g., to support) multiple RATs using at least some shared communication circuitry, as previously noted. If the shared communication circuitry includes one or both of the antennas which might be used to enable receive diversity, enabling receive diversity might preclude the other RAT from communicating while the UE 106 is monitoring the paging channel. Thus, if desired, receive diversity may be enabled while monitoring the paging channel only at selected times when it may be expected to have a significant impact on user experience, such as if the UE 106 is experiencing difficulty decoding paging messages using a single antenna.

Accordingly, in some instances receive diversity may be enabled for a specific (e.g., predetermined) period of time and/or number of subsequent paging occasions in response to determining that the message length indicated in the message length field is incorrect. For example, receive diversity might be enabled for five (or four, three, two, or any other number of) subsequent paging occasions after determining that the message length indicated in the message length field is incorrect. If desired, receive diversity might also or alternatively be enabled for the remainder of the current paging occasion upon determining that the message length indicated in the message length field is incorrect.

If no further errors are detected while attempting to receive and decode paging messages during the period of time for which receive diversity is enabled, receive diversity may again be disabled, such that on one or more paging occasions subsequent to receive diversity being disabled only one antenna may be used to monitor the paging channel and perform any other activities on those one or more paging occasions. However, if errors continue to be detected (e.g., if a subsequent paging message length field is determined to be incorrect, or a subsequent paging message fails a CRC check, among various possibilities), the period of time for which receive diversity is enabled may be extended. For example, if a subsequent error is detected, the length of time and/or number of subsequent paging occasions for which receive diversity is enabled may be renewed/extended.

It is worth noting that initially, while monitoring the paging channel, detecting the indication of the first paging message, receiving and decoding the message length field, and determining that the message length indicated in the message length field is incorrect (e.g., as described hereinabove with respect to steps 502, 504, 506, and 508 of FIG. 5), receive diversity may not have been enabled. For example, steps 502, 504, 506, and 508 may have been performed using a single antenna.

However, it is also possible that receive diversity may have already been enabled. For example, if the message length indicated in the message length field of a recently (e.g., in the same paging occasion or a recent paging occasion) detected paging message was incorrect, receive diversity might have already been enabled for the current paging occasion. In this case, enabling receive diversity in response to determining that the message length indicated in the message length field of the first paging message is incorrect may more particularly include renewing or extending receive diversity for the at least one subsequent paging occasion.

Thus, by utilizing the method of FIG. 5 as provided above according to various embodiments, a UE 106 may be able to at least temporarily enable receive diversity in response to detecting paging message errors, and in particular in response to detecting an incorrectly decoded paging message length. This may allow the UE 106 to improve the chances of correctly decoding subsequent paging messages in difficult reception conditions, without requiring receive diversity to be permanently enabled. Furthermore, by detecting an incorrectly decoded paging message length, a UE 106 may be able to cease attempting to decode a paging message which is expected to be unsuccessfully decoded, which may reduce power consumption by the UE 106.

### Additional Information

The following description provides certain exemplary details of one scenario in conjunction with which the method of FIG. 5 may be used. Note that while the following information is provided for illustrative purposes of certain exemplary details which may be used in some implementations, this information is provided by way of example only, and is not intended to be limiting to the disclosure as a whole.

In particular, the exemplary scenario described may relate to the 3GPP2 radio access technology CDMA 2000. CDMA 2000, like many radio access technologies, may provide the possibility of performing discontinuous reception (DRX) in certain states or modes of operation. DRX operation may include monitoring a paging channel for paging messages (among other possible activities) during an active portion of each periodic DRX cycle, and sleeping between those active portions of each DRX cycle.

In CDMA 2000, the paging channel (PCH) may be slotted with one 80 ms PCH slot, which may be divided into four 20 ms PCH frames. Each frame may in turn be divided into two 10 ms half frames. Depending on the Paging Channel Rate (PRAT), which may be indicated in the SYNC channel to be either 4.8 kbps or 9.6 kbps, each half frame may therefore fit 48 or 96 bits respectively.

Each half-frame may include a 1-bit synchronized capsule indicator (SCI) field and a 47 or 95 bit body field. An SCI of 1 may indicate the start of a new PCH message capsule in the current half-frame and an SCI of 0 may indicate otherwise. A message capsule on the PCH may occupy more than one PCH half-frame.

A wireless device which is monitoring the PCH may accordingly detect whether the SCI at the beginning of each half-frame is 1 or 0. If it detects a 1, the wireless device may proceed to decode the paging channel message indicated by the SCI. Note that the SCI in this exemplary scenario may function as an indicator bit of the presence or absence of an upcoming paging message; thus, when set to 1, an SCI might function as an indication of an incoming paging message (such as the “first paging message” described with respect to step 504 of FIG. 5).

The paging channel message capsule may be structured with a message length (“MSG_LEN”) field, a body field, a cyclic redundancy check (CRC) field, and possibly padding. The message length field may indicate the length of the paging channel message capsule in bytes, and may be 8 bits long. Based on the message length field, the wireless device may then be able to decode and construct the complete paging message from the current and subsequent half-frames. When all bits have been collected, a 30-bit CRC check (e.g., using the data decoded from the CRC field) may be performed to determine whether the decoded message is good (e.g., if the CRC check confirms the accuracy of the message) or not.

While the 8-bit length of the MSG_LEN field in this exemplary scenario implies that the length of the body could be up to 255 bytes (2040 bits) long, there may be other limits to the actual message body. For example, per 3GPP2 specifications, the multiple messages that can be encapsulated in a paging channel message body may have a maximum size of 1146 bits, e.g., according to C.S0005 section 3.7, C.S0004 sections 3.1.2.1 and 3.1.2.2, and C.S0003 2.2.1.1.1.3. Since the MSG_LEN is the sum of the MSG_LEN field (8 bits), body field (variable up to 1146 bits) and CRC field (30 bits), the maximum transmittable paging channel message by the network in this exemplary case may be 1184 bits (148 bytes).

If the wireless device incorrectly decodes the MSG_LEN field (e.g., due to poor channel conditions), the device might attempt to collect the corresponding message bits, but fail to correctly decode the paging message. Two possible failure scenarios include:

If an SCI of 1 is detected, the wireless device may interrupt the process and start decoding a new PCH message, thus aborting decoding the current message, or

If all bits corresponding to the (incorrect) message length are collected, the CRC check will fail.

In both these cases, the wireless device may not only fail to successfully decode a paging message intended for the wireless device (which may negatively affect user experience, e.g., as a result of a missed or at least delayed call), but may also needlessly expend energy (and thus drain the battery of the wireless device) by attempting to collect and decode (at least part of) an incorrect message.

However, if techniques such as those described with respect to, inter alia, FIG. 5 are implemented, it may be possible for a wireless device to detect and respond to incorrectly decoded paging message lengths in a manner that avoids expending energy attempting to decode paging messages which (due to the incorrectly decoded paging message length) are known to be invalid, and/or improves the chances of correctly receiving subsequent paging messages.

For example, a wireless device configured to implement the features described with respect to, inter alia, FIG. 5 may be able to detect and respond to certain error conditions indicative of an incorrectly decoded paging message length. Thus, if the MSG_LEN field of a paging message indicates that the length of the paging message is longer than the maximum transmittable paging message (i.e., longer than 1184 bits, in this exemplary scenario), this may be an error condition indicative of an incorrectly decoded paging message length. Another such error condition could include decoding a ‘1’ in the SCI field of a half-frame which is in the process of being decoded as specified by the paging message length field of a previous paging message. Detecting an SCI of 1 in any such half-frames might be taken as an indication of a newly incoming paging message, which might indicate that the message length of the previous paging message may have been incorrectly decoded (e.g., the actual paging message length may have been less than the decoded paging message length). Both such conditions may at least be indicative of incorrect decoding of the information being received on the paging channel, and may in particular be indicative of an incorrectly decoded paging message length.

In such cases, the wireless device may cease attempting to decode the current paging message, since it may be highly likely to contain errors. Furthermore, the wireless device may at least temporarily enable receive diversity for monitoring and decoding the paging channel in response to detecting such conditions. This may improve the likelihood of correctly decoding subsequent paging messages, in particular since such conditions may often be caused by difficult channel conditions which may at least in some cases be countered by utilizing multiple antennas for receive diversity.

Embodiments of the present disclosure may be realized in any of various forms. For example some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE 106) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method for operating a wireless user equipment (UE) device, the method comprising:
monitoring a paging channel;
detecting an indication of a first paging message on the paging channel, wherein the first paging message comprises a message length field indicating a message length of the first paging message;
receiving and decoding the message length field of the first paging message on the paging channel;
determining that the message length indicated in the message length field is incorrect;
enabling receive diversity for at least one subsequent paging occasion in response to determining that the message length indicated in the message length field is incorrect.

2. The method of claim 1, the method further comprising:
ceasing to decode the first paging message after determining that the message length indicated in the message length field is incorrect, based on determining that the message length indicated in the message length field is incorrect.

3. The method of claim 1, wherein determining that the message length indicated in the message length field is incorrect comprises:
determining that the message length field indicates a message length which is longer than a specified maximum paging message length.

4. The method of claim 1, wherein determining that the message length indicated in the message length field is incorrect comprises:
detecting an indication of a second paging message on the paging channel while decoding the first paging message according to the message length indicated in the message length field.

5. The method of claim 1,
wherein the UE operates according to a 3GPP2 cellular communication standard.

6. The method of claim 1,
wherein enabling receive diversity comprises utilizing multiple antennas of the UE to monitor the paging channel for the at least one subsequent paging occasion.

7. The method of claim 1, the method further comprising:
disabling receive diversity after the at least one subsequent paging occasion if no further errors are detected while attempting to receive and decode paging messages on the at least one subsequent paging occasion.

8. A wireless user equipment (UE) device, comprising:
a radio, comprising at least two antennas configured for wireless communication;
a processing element operably coupled to the radio;
wherein the radio and the processing element are configured to:
monitor a paging channel;
detect an indication of a first paging message on the paging channel, wherein the first paging message comprises a message length field indicating a message length of the first paging message;
receive and decoding the message length field of the first paging message on the paging channel;
determine that the message length indicated in the message length field is incorrect;
enable receive diversity for at least one subsequent paging occasion in response to determining that the message length indicated in the message length field is incorrect.

9. The UE of claim 8,
wherein enabling receive diversity comprises utilizing at least two antennas of the radio to monitor the paging channel for the at least one subsequent paging occasion.

10. The UE of claim 8,
wherein the radio and the processing element are configured to monitor the paging channel, detect the indication of the first paging message, and receive and decode the message length field of the paging message with receive diversity disabled,
wherein enabling receive diversity for the at least one subsequent paging occasion in response to determining that the message length indicated in the message length field is incorrect configures the radio and the processing element to monitor the paging channel, detect indications of paging messages, and receive and decode message length fields of paging messages with receive diversity enabled for the at least one subsequent paging occasion.

11. The UE of claim 10,
wherein monitoring the paging channel, detecting the indication of the first paging message, and receiving and decoding the message length field of the paging message with receive diversity disabled comprises using only one antenna of the radio to monitor the paging channel, detect the indication of the first paging message, and receive and decode the message length field of the paging message.

12. The UE of claim 8,
wherein the radio and the processing element are configured to monitor the paging channel, detect the indication of the first paging message, and receive and decode the message length field of the paging message with receive diversity enabled,
wherein enabling receive diversity for the at least one subsequent paging occasion in response to determining that the message length indicated in the message length field is incorrect comprises extending the use of receive diversity for the at least one subsequent paging occasion.

13. The UE of claim 8,
wherein, in response to determining that the message length indicated in the message length field is incorrect, the radio and the processing element are configured to enable receive diversity for one of:
a predetermined amount of time; or
a predetermined number of paging occasions,
wherein the radio and the processing element are configured to disable receive diversity after the predetermined amount of time or predetermined number of paging occasions if no further errors are detected while attempting to receive and decode paging messages during the predetermined amount of time or predetermined number of paging occasions.

14. The UE of claim 8,
wherein the UE is configured to communicate using at least a first radio access technology and a second radio access technology,
wherein when receive diversity is disabled, the UE is capable of utilizing the at least two antennas of the radio to communicate using each of the first and second radio access technologies simultaneously,
wherein when receive diversity is enabled, the UE is able to communicate using only one of the first or second radio access technology at a time.

15. A non-transitory computer accessible memory medium comprising program instructions for a wireless user equipment (UE) device, wherein when executed, the program instructions cause the UE to:
monitor a paging channel at a first paging occasion, wherein a first antenna is used to monitor the paging channel at the first paging occasion;
detect an indication of a first paging message on the paging channel using the first antenna during the first paging occasion, wherein the first paging message comprises a message length field indicating a message length of the first paging message;
receive and decoding the message length field of the first paging message on the paging channel using the first antenna during the first paging occasion;
determine that the message length indicated in the message length field of the first paging message is incorrect;
monitor the paging channel for at least one subsequent paging occasion, wherein the first antenna and a second antenna are used to monitor the paging channel at the at least one subsequent paging occasion in response to determining that the message length indicated in the message length field of the first paging message is incorrect.

16. The memory medium of claim 15,
wherein the at least one subsequent paging occasion comprises a plurality of subsequent paging occasions,
wherein the program instructions further cause the UE to monitor the paging channel using only the first antenna after the plurality of subsequent paging occasions if no further errors are detected while attempting to receive and decode paging messages during the plurality of subsequent paging occasions,
wherein the program instructions further cause the UE to monitor the paging channel using the first antenna and the second antenna for at least one additional paging occasion after the plurality of subsequent paging occasions one or more further errors are detected while attempting to receive and decode paging messages during the plurality of subsequent paging occasions.

17. The memory medium of claim 15, wherein determining that the message length indicated in the message length field of the first paging message is incorrect comprises one or more of:
determining that the message length field indicates a message length which is longer than a specified maximum paging message length; or
detecting an indication of a second paging message on the paging channel while decoding the first paging message.

18. The memory medium of claim 15, wherein the program instructions further cause the UE to:
cease decoding the first paging message after determining that the message length indicated in the message length field of the first paging message is incorrect, based on determining that the message length indicated in the message length field of the first paging message is incorrect.

19. The memory medium of claim 15,
wherein monitoring the paging channel, detecting the indication of the first paging message, and receiving and decoding the message length field of the first paging message are performed in accordance with a 3GPP2 radio access technology,
wherein the indication of the first paging message comprises a synchronized capsule indicator (SCI) having a value of 1.

20. The memory medium of claim 15,
wherein monitoring the paging channel for the first paging occasion and the at least one subsequent paging occasion are performed as part of discontinuous reception operation of the UE.
